(19) United States
(12) Patent Application Publication
(10) Pub. No.: US 2005/0014109 A1
(43) Pub. Date: Jan. 20, 2005

(54) TEMPORARY TOOTH BRIDGE USING VENEER SHELL PLATE

(76) Inventor: Hyo-Bum Lim, Seoul (KR)

Correspondence Address: GREENBERG & LIEBERMAN, 314 PHILADELPHIA AVE., TAKOMA PARK, MD, 20912, US

(21) Appl. No.: 10/710,408

(22) Filed: Jul. 8, 2004

(30) Foreign Application Priority Data
Jul. 8, 2003 (KR) 10-2003-0045979

(51) Int. Cl. A61C 5/08

(52) U.S. Cl. 433/218; 433/215

(57) ABSTRACT

The present invention relates to a temporary bridge tooth using a resin veneer shell plate that is characterized in that each veneer shell with a shape of a front tooth is connected with each other, and the connected shape is a curve shape like the shape of actual front teeth of a human, and the entire construction of the temporary bridge tooth is formed in a thin plate shape, and a connected portion of each veneer shell is thinner than the other portions.

### CROSS REFERENCE TO RELATED APPLICATIONS

Priority is hereby claimed to Korean patent application serial number 10-2003-0045979 filed on Jul. 8, 2003 in the name of Hyo-Bum Lim.

### BACKGROUND OF INVENTION

The present invention relates to a temporary tooth bridge using a veneer shell plate, and in particular to a temporary tooth bridge using a veneer shell plate capable of easily fabricating a temporary tooth bridge that can be used by temporarily inserting into teeth until a tooth bridge is fabricated in a dental laboratory when a front tooth is removed or damaged.

In a dental hospital, in the case that a front tooth is removed or damaged, when prosthetics is needed, it is not performed using a metal. Differently from a grinding tooth, an outer look is not good. In this case, prosthetics is performed using artificial bridge or crown 20, 22 made of a porcelain material. Here, the prosthetics represents a bridge by which two or more than two teeth are connected or represents a crown with a shape of tooth. In the present invention, front teeth represent front side teeth including canine teeth.

FIGS. 3 are plane, front and bottom views of a bridge corresponding to three teeth. As shown in FIGS. 1 and 2, when prosthetics is needed, an abutment tooth 10 is sharpened, and a bridge 20 is inserted into the sharpened portion. It takes about 10 days for fabricating the bridge 20 in the dental laboratory after the abutment tooth 10 is sharpened. During the above time period, a patient should live with the teeth in a shape of FIG. 2. In a stat that the abutment tooth 10 is that sharpened, it looks bad, so that it is impossible to have a normal life. In order to overcome the above problems, in the dental hospital, a temporary bridge 20 having the same shape as the bridge 20 is inserted. At this time, there are important things. Namely, when the temporary bridge 20 is inserted after the tooth is sharpened, the temporary bridge 20 should be fabricated before the tooth is sharpened, so that it is possible to insert the temporary bridge 20 at the time when the tooth is sharpened.

However, the process for fabricating the temporary bridge 20 is very complicated. As shown in FIG. 1, a sample of a tooth needing a prosthetics should be made using limestone a few days before the abutment tooth 10 is made in the dental laboratory. As shown in FIG. 2, the abutment tooth 10 is sharpened in the limestone sample. An instant hardening resin mixture covers the removed portion of the tooth and the sharpened abutment tooth 15. When it is hardened, it is removed and then is processed and polished like the actual tooth. Therefore, the temporary bridge 20 is fabricated as shown in FIG. 3. As shown in FIG. 4, the finished bridge is moved to the sharpened abutment tooth 15 and is temporarily used until the prosthetics is finished. Namely, complicated processes are performed for fabricating the conventional temporary bridge 20.

### SUMMARY OF INVENTION

Accordingly, it is an object of the present invention to overcome the above problems that in the conventional art, it is very difficult to accurately fabricate a temporary tooth in the same shape as an actual tooth using a resin mixture by a worker of a temporary bridge.

It is another object of the present invention to provide a temporary tooth bridge using a veneer shell plate in which an accurately made veneer shell plate is used as a finished tooth, so that a temporary bridge is removed as soon as possible at the time when a corresponding tooth is sharpened.

To achieve the above objects, there is provided a temporary bridge tooth using a resin veneer shell plate that is characterized in that each veneer shell with a shape of a front tooth is connected with each other, and the connected shape is a curve shape like the shape of actual front teeth of a human, and the entire construction of the temporary bridge tooth is formed in a thin plate shape, and a connected portion of each veneer shell is thinner than the other portions.

In addition, in the veneer shell for the temporary bridge tooth according to the present invention, one veneer shell is separated from the veneer shell plate for the temporary veneer shell plate and is formed.

### BRIEF DESCRIPTION OF DRAWINGS

The present invention will become better understood with reference to the accompanying drawings which are given only by way of illustration and thus are not limitative of the present invention, wherein;

FIGS. 1 through 8 are views of a first use method of a temporary tooth bridge using a veneer shell plate according to the present invention;

FIGS. 9 through 14 are views of a second use method of a temporary tooth bridge using a veneer shell plate according to the present invention; and

FIGS. 15 and 16 are views for describing a temporary tooth bridge using a veneer shell plate according to the present invention.

### DETAILED DESCRIPTION

The preferred embodiment of the present invention will be described with reference to the accompanying drawings.

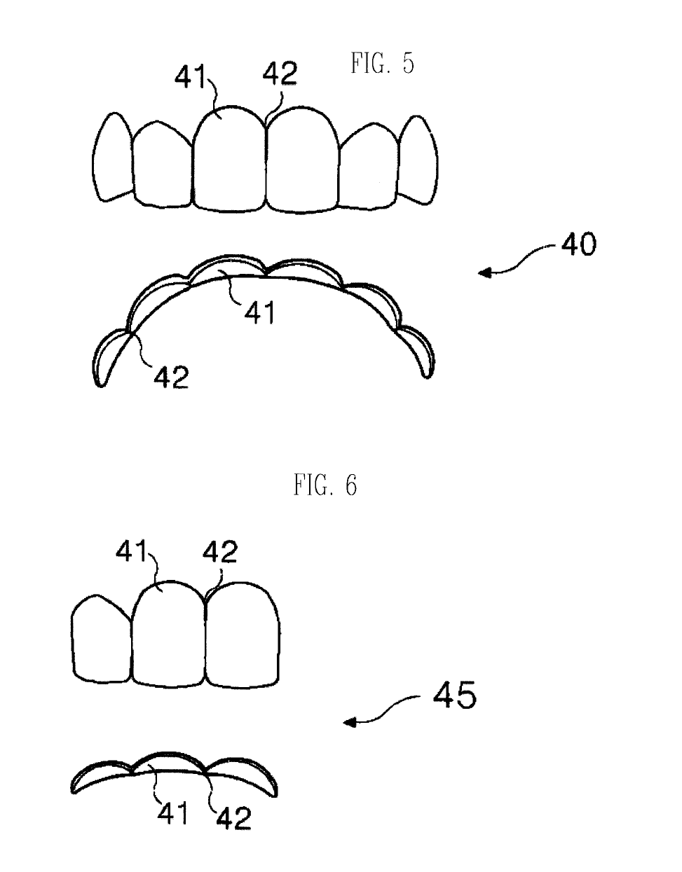

As shown in FIG. 5, a veneer shell 40 for a temporary bridge according to the present invention is formed in a structure that front teeth are connected in a curve shape. The entire construction is formed in a thin plate shape. A connection part 42 of a veneer shell 41 corresponding to each front tooth is formed thinner than other parts and is formed of resin. The number of the veneer shells 41 forming the veneer shell plate 40 is two or more than two and is preferably 6.

In addition, the veneer shell plate 40 is preferably fabricated in a molding method adapted when a resin product is fabricated. Namely, a mold matching with the shape of the veneer shell plate 40 is fabricated, and liquid resin is filled therein.

When the veneer shell plate 45 is used, the veneer shell plate 45 is attached to an outer side of a corresponding tooth, and a dental instant hardening direct resin mixture 46 is covered on an inner side of the same, for thereby being integrated with the veneer shell plate 45. Therefore, the veneer shell plates 40, 45 should be made of a certain material instantly adhered with the dental instant hardening direct resin mixture 46.

The dental instant hardening direct resin mixture 46 is a soft dough phase fabricated in such a manner that a powder shape material (polymer) and a liquid phase material (monomer) are mixed. The direct resin mixture 46 is a typical one generally used in the dental laboratory. Since the dental instant hardening direct resin mixture 46 is well adapted to all kinds of materials, the material of the veneer shell plate 40 is not limited the kinds of resins.

The method of use of the veneer shell plate 40 is divided into two methods. One method is adapted when a front tooth is removed (hereinafter referred to as first use method), and the other method is adapted when a front tooth is damaged (hereinafter referred to second use method).

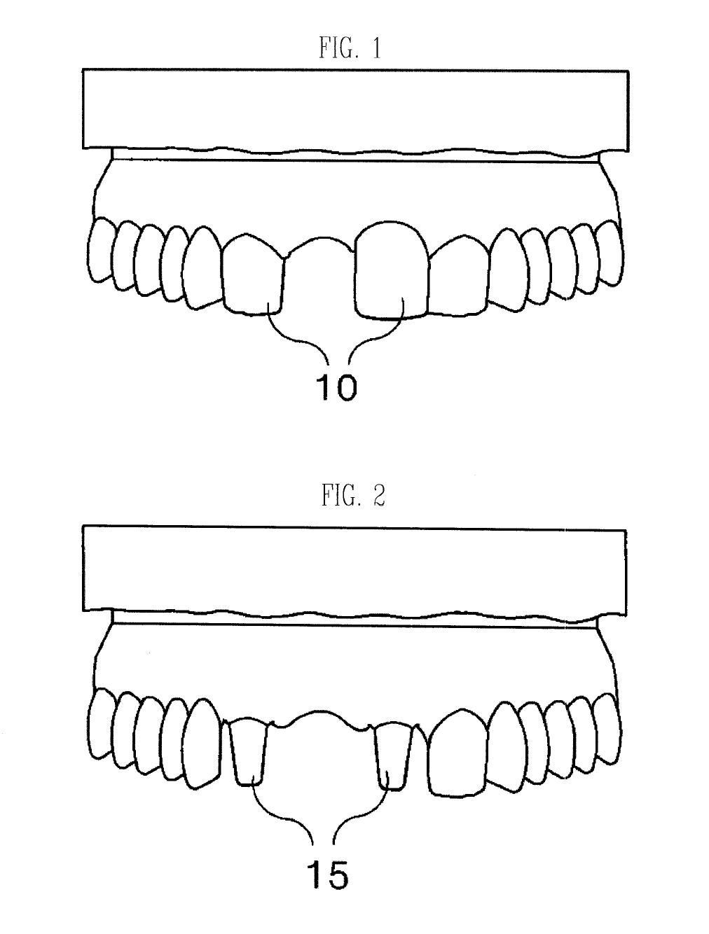

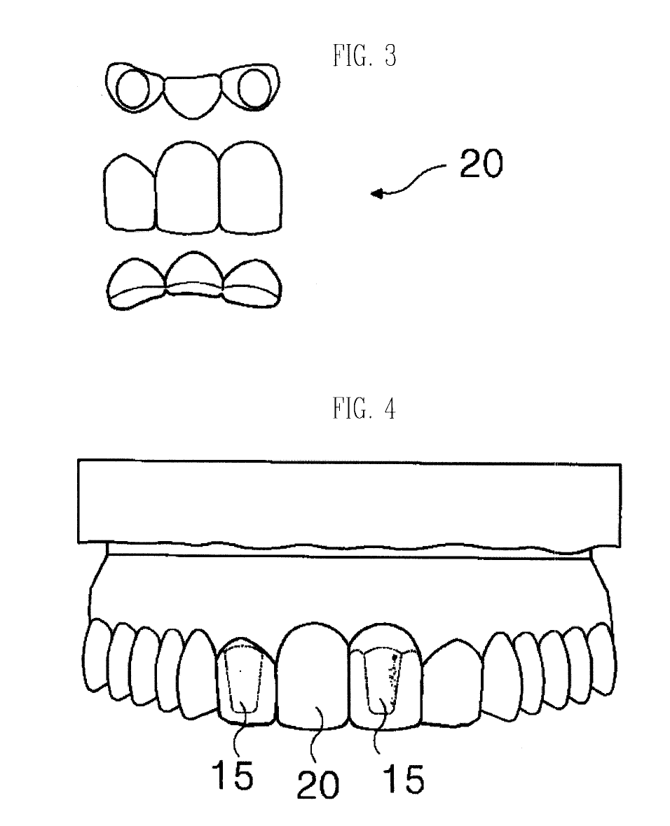

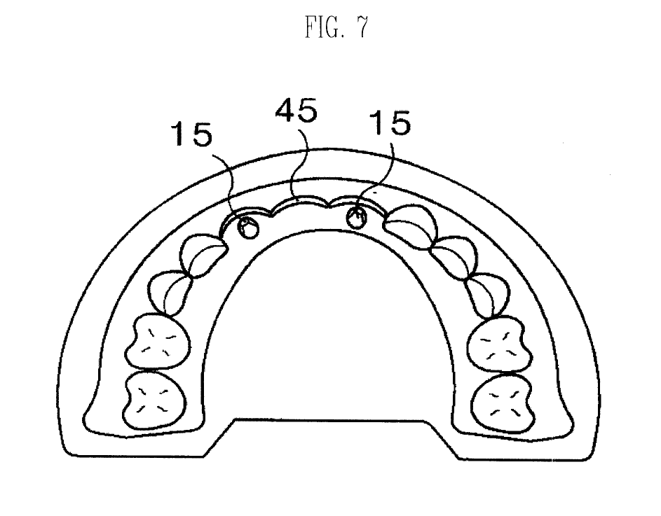

As shown in FIGS. 1 and 2, in the first use method, a dentist sharpens the sides of the abutment tooth 10 corresponding the portion in which the front tooth is removed. As shown in FIG. 6, the veneer shell plate 40 is cut by the number needed to a corresponding portion. At this time, a connection part 42 between the veneer shells 41 is thinner than the other parts, so that the same can be manually cut by hands. The veneer shell plate 45 is attached to the portion in which the front tooth is removed, and the abutment tooth 15 as shown in FIG. 7.

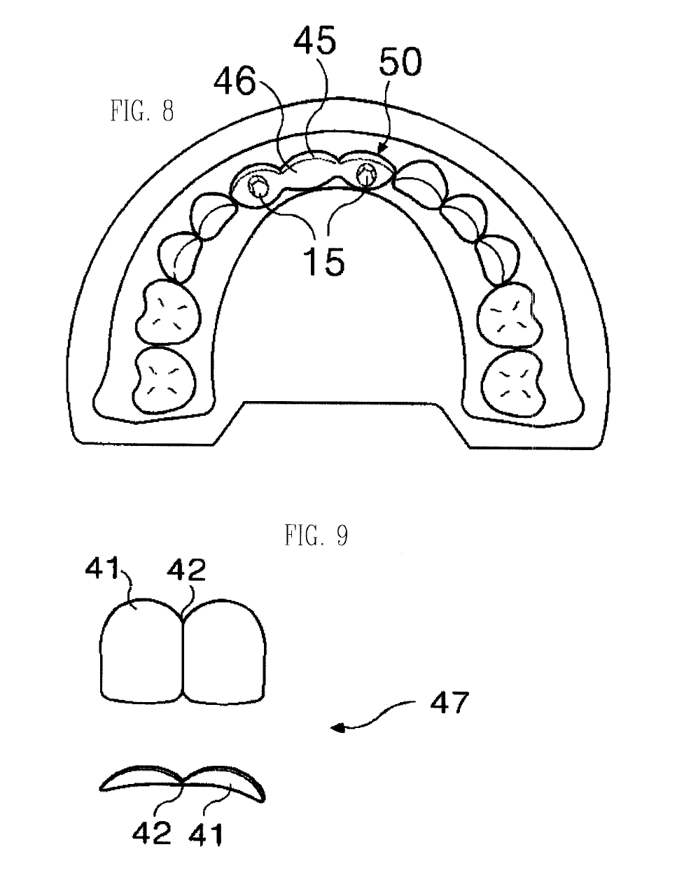

As shown in FIG. 8, the instant hardening direct resin mixture 46 is covered from the rear sides of the portion in which the front tooth is removed and the sharpened abutment tooth 15 and is integrally attached to the veneer shell plate 41. Next, a resultant structure 50 is removed from the abutment tooth 15 after the dental instant hardening direct resin mixture 46 is hardened, and the resultant structure 50 is treated based on the shape of the normal front tooth, for thereby finishing a temporary bridge 20.

Next, the finished temporary bridge tooth 20 is inserted into the sharpened abutment tooth 15 and is used until the bridge tooth is finished. It is used for about 10 days. When the bridge tooth 20 of the same shape is finished, the bridge tooth is attached.

In the first use method, the veneer shell plate 40 having three or more than three veneer shells 41 is needed. In the case that one front tooth is removed, one veneer shell 41 corresponding to the removed tooth and two veneer shells 41 corresponding to two or more than two cut abutment teeth 15 are needed. Namely, totally three or more than three veneer shells 41 are needed. In the case that two front teeth are removed, four or more than four veneer shell plates 41 are needed. The veneer shell plate 40 preferably needs six veneer shells 41. If needed, the number of the same is not limited.

In the veneer shell plate 40 adapted to the first use method, three or more than three veneer shells 41 are connected in a curve shape to correspond with the shape of the front tooth. For example, each veneer shell 41 is sequentially connected in a wide or sharp shape to be matched with the shape of an actual tooth.

In addition, the veneer shell plate 40 should be a thin plate shape. Since the dentist may cut the abutment tooth 10 by a little, the veneer shell plate 40 should be thin, so that the temporary bridge tooth 20 is not protruded more than the actual front tooth as shown in FIGS. 7 and 8.

The shapes of the teeth are similar, but the sizes of the same are different. Therefore, it is needed to fabricate the veneer shell plate 40 in large, middle, and small sizes or in different sizes, so that people select a desired size and shape.

The second use method of the veneer shell plate 40 will be described with reference to FIGS. 9 through 14.

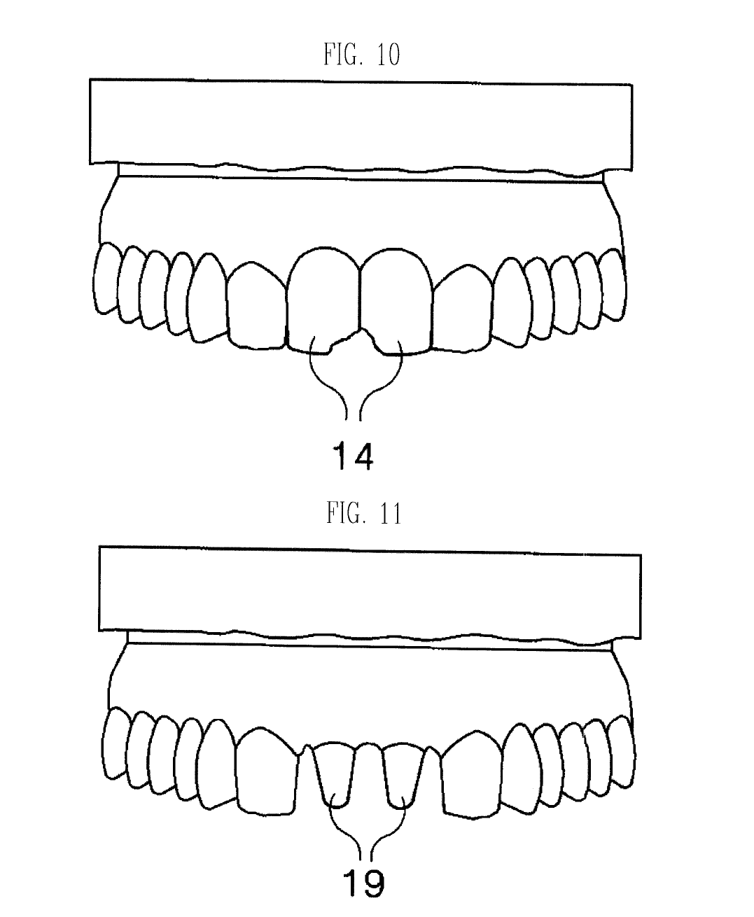

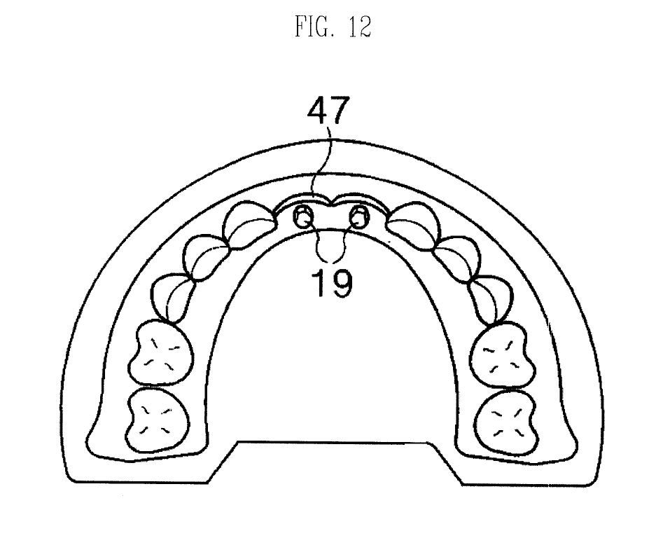

As shown in FIGS. 10 and 11, the dentist cuts the damaged front teeth 14, and the veneer shell plate 40 is cut by the number needed to a corresponding portion. FIG. 9 is a front and bottom view of the cut veneer shell plate 47.

In the present invention, since two or more than two veneer shells 41 are adapted, when two front teeth are concurrently damaged, this method is adapted. In the case that only one front tooth is damaged, it will be described later. The cut veneer shell plate 47 is attached to the cut front teeth 14.

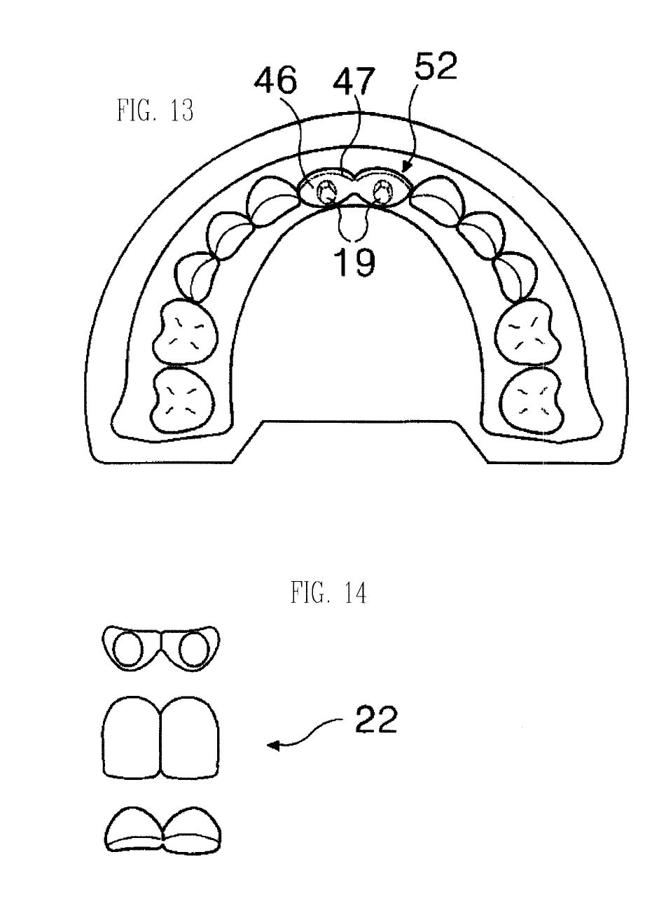

As shown in FIGS. 12 and 13, the dental instant hardening direct resin mixture 46 is covered from the rear side of the cut front teeth 19 and is integrally attached to the veneer shell plate 47. After the dental instant hardening direct resin mixture 46, a resultant structure 52 is removed from the cut front teeth 19, and the resultant structure 52 is processed based on the shape of the normal front tooth. As shown in FIG. 14, the temporary bridge tooth 22 is fabricated. FIG. 14 is a plane, front and bottom view of the temporary bridge tooth 22.

The temporary bridge veneer shell 49 according to the present invention has a shape of one front tooth and is formed in a thin plate shape and is formed of resin.

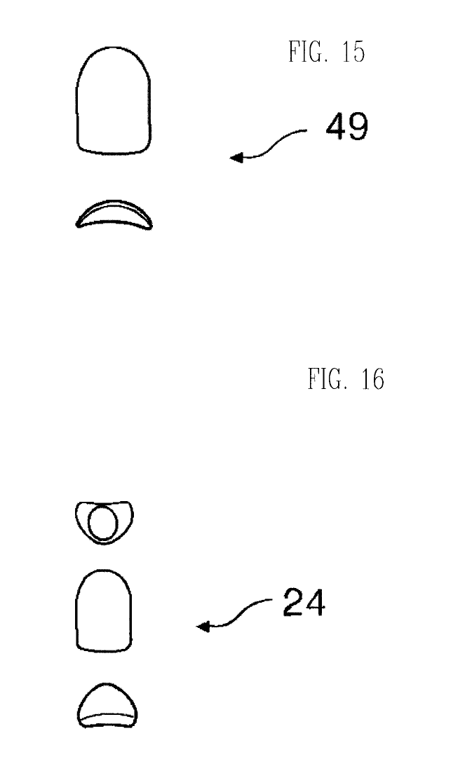

As shown in FIG. 15, the veneer shell 49 of the temporary bridge tooth according to the present invention means a fabrication of the veneer shell 41 forming the veneer shell plate 40. The veneer shell plate 40 may be cut for thereby fabricating one veneer shell 41. In addition, liquid resin may be filled in a mold corresponding to a shape of one veneer shell 49, thus fabricating a single veneer shell 49. The detailed fabrication method is the same as the fabrication method of the above-described veneer shell plate 40. In this case, only the mold may be different. The method of use is same as the second use method of the veneer shell plate 40, except that it is adapted only when one front tooth is damaged. FIG. 16 is a plane, front and bottom view of the temporary bridge tooth 24 fabricated using the veneer shell 49.

Industrial Applicability

As described above, in the present invention, it is possible to fabricate a temporary bridge tooth within a mouth for a very short time period as compared to the conventional temporary bridge fabrication method in which the sample of a tooth is made, and a limestone mold is formed, and an abutment tooth or damaged tooth is cut based on the limestone mold, thus fabricating a temporary bridge tooth.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A temporary bridge tooth using a resin veneer shell plate that is characterized in that each veneer shell with a shape of a front tooth is connected with each other, and the connected shape is a curve shape like the shape of actual front teeth of a human, and the entire construction of the temporary bridge tooth is formed in a thin plate shape, and a connected portion of each veneer shell is thinner than the other portions.

2. The tooth of claim 1, wherein said veneer shell plate is formed of veneer shells.
